(19) United States
(12) Patent Application Publication
(10) Pub. No.: US 2024/0140438 A1
(43) Pub. Date: May 2, 2024

(54) PERCEPTION BLOCKAGE PREDICTION AND SUPERVISION FOR PERFORMING INFORMATION CLOUD LOCALIZATION

(71) Applicant: VALEO NORTH AMERICA, INC., Troy, MI (US)

(72) Inventors: Thomas HEITZMANN, Troy, MI (US); Romain DEMARETS, Creteil (FR)

(73) Assignee: VALEO NORTH AMERICA, INC., Troy, MI (US)

(21) Appl. No.: 18/050,306

(22) Filed: Oct. 27, 2022

(51) Int. Cl. B60W 40/02; B60W 50/14; B60W 60/00

(52) U.S. Cl. CPC B60W 40/02; B60W 50/14; B60W 60/001; B60W 2420/52; B60W 2420/54; B60W 2554/4041

(57) ABSTRACT

Method for perception blockage prediction and supervision for performing information cloud localization in an ego vehicle based on an information cloud map and a sensor information cloud generated based on sensor information provided by at least one environment sensor of the ego vehicle. The method comprises perceiving a surrounding of the ego vehicle. The method comprises detecting and localizing at least one object in the surrounding of the ego vehicle, which is not contained in the information cloud map. The method comprises determining a future obstruction of at least one part of the information cloud map for the at least one environment sensor of the ego vehicle based on the localization of the at least one object detected in the surrounding of the ego vehicle. The method comprises generating a warning in case the future obstruction of the at least one part of the information cloud map has been determined.

### TECHNICAL FIELD

Localization of vehicles is becoming a more and more important issue, in particular in the areas of ADAS (advanced driving assistance system) or robotics. A high number of information cloud map based localization techniques are appearing especially in these areas. Information cloud maps provide a cloud of information, e.g. a feature cloud and/or a point cloud, which is typically provided as a kind of map to the ego vehicle. These information cloud maps can be provided e.g. instead of “conventional” map representations of the environment.

In contrast to a “conventional” map made for humans, the information cloud map provides a cloud-like representation of the environment of the vehicle. The information cloud map contains information in respect to typically non-movable objects, which together define the environment. The vehicle generates a similar representation of the environment using its environment sensors. Based on the information cloud map together with the sensor information cloud, a current position of the ego vehicle can be determined based on a matching of the sensor information cloud and the information cloud map. Hence, a relative position between the ego vehicle and objects represented by the information provided in the information cloud map can be determined. Based on known positions of information elements provided in the information cloud, the relative position of the ego vehicle can be used to determine an absolute position of the ego vehicle, i.e. a unique position on earth.

This kind of localization provides an alternative means to conventional localization techniques, which are based on reception of position signals received from a global navigation satellite system (GNSS). Currently available GNSS include NAVSTAR GPS (Global Positioning System), typically referred to as GPS only, GLONASS, Galileo or Beidou.

### BACKGROUND

Information cloud map based localization techniques can achieve a precision level comparable to other high-end localization technologies such as GNSS (Global Navigation Satellite System) with RTK correction (Real-Time Kinematic), and provide a suitable solution for automated driving, autonomous driving and/or robotic navigation. The information cloud localization is typically reliable and is able to provide position information for the ego vehicle with a higher refresh rate compared to typical state of the Art GNSS.

One general objective in localization is to handle only a small amount of data. Hence, the information cloud map is typically reduced in its extension, i.e. the information cloud map only covers a relevant region of interest. A further reduction can be performed by removing information from the information cloud map, so that the information of the information cloud map has a reduced density of information. However, reducing the provided information of the “known environment” can be dramatic, e.g. if the information of the information cloud map is obstructed. In this case, the sensor information provided by the environment sensor(s) of the ego vehicle, which together provide the sensor information cloud, cannot be suitably matched with the information cloud map, and localization is inaccurate or even fails. In these cases, immediate countermeasures are required on order to ensure safe driving.

### SUMMARY

A method for perception blockage prediction and supervision for performing information cloud localization in an ego vehicle based on an information cloud map and a sensor information cloud generated based on sensor information provided by at least one environment sensor of the ego vehicle. The method further comprises perceiving a surrounding of the ego vehicle. The method further comprises detecting and localizing at least one object in the surrounding of the ego vehicle, which is not contained in the information cloud map. The method further comprises determining a future obstruction of at least one part of the information cloud map for the at least one environment sensor of the ego vehicle based on the localization of the at least one object detected in the surrounding of the ego vehicle. The method further comprises generating a warning in case the future obstruction of the at least one part of the information cloud map has been determined.

A driving support system for use in an ego vehicle. The driving support system further comprises at least one environment sensor and a control unit adapted to perceive a surrounding of the ego vehicle. The driving support system further comprises at least one environment sensor and a control unit adapted to detect and localize at least one object in the surrounding of the ego vehicle, which is not contained in the information cloud map. The driving support system further comprises at least one environment sensor and a control unit adapted to determine a future obstruction of at least one part of the information cloud map for the at least one environment sensor of the ego vehicle based on the localization of the at least one object detected in the surrounding of the ego vehicle. The driving support system further comprises at least one environment sensor and a control unit adapted to generate a warning in case the future obstruction of the at least one part of the information cloud map has been determined.

A non-transitory computer-readable storage medium storing instructions, which when executed on a computer, cause the computer to perform a method for perception blockage prediction and supervision for performing information cloud localization in an ego vehicle based on an information cloud map and a sensor information cloud generated based on sensor information provided by at least one environment sensor of the ego vehicle. The non-transitory computer-readable storage medium storing instructions executed on the computer further comprises the method of perceiving a surrounding of the ego vehicle. The non-transitory computer-readable storage medium storing instructions executed on the computer further comprises the method of detecting and localizing at least one object in the surrounding of the ego vehicle, which is not contained in the information cloud map. The non-transitory computer-readable storage medium storing instructions executed on the computer further comprises the method of determining a future obstruction of at least one part of the information cloud map for the at least one environment sensor of the ego vehicle based on the localization of the at least one object detected in the surrounding of the ego vehicle. The non-transitory computer-readable storage medium storing instructions executed on the computer further comprises the method of generating a warning in case the future obstruction of the at least one part of the information cloud map has been determined.

The foregoing elements and features may be combined in various combinations without exclusivity, unless expressly indicated otherwise. These elements and features, as well as the operation thereof, will become more apparent in view of the following detailed description with accompanying drawings. It should be understood that the following detailed description and accompanying drawings are intended to be exemplary in nature and non-limiting.

### BRIEF DESCRIPTION OF THE DRAWINGS

The embodiments of the present disclosure are pointed out with particularity in the appended claims. Various other features will become more apparent to those skilled in the art from the following detailed description of the disclosed non-limiting embodiments and will be best understood by referring to the following detailed description along with the accompanying drawings in which:

FIG. 1 shows a schematic view of an ego-vehicle with a driving support system comprising multiple environment sensors and a control unit, whereby the driving support system is adapted to perform a method for perception blockage prediction and supervision for performing information cloud localization in an ego vehicle based on an information cloud map and a sensor information cloud generated based on sensor information provided by at least one environment sensor of the ego vehicle.

FIG. 2 shows a schematic view of a first driving scenario with the ego vehicle approaching different third party vehicles parking at lateral borders of a street or road ahead of the ego vehicle.

FIG. 3 shows a schematic view based on the first driving scenario of FIG. 2, where the ego vehicle has reached a position laterally between the third party vehicles parking at the lateral borders of a street or road.

FIG. 4 shows a schematic view of a second driving scenario with the ego vehicle driving on a central driving lane of a street or road together with different third party vehicles driving individually on neighboring driving lanes, whereby the vehicles driving on the neighboring driving lanes are located ahead of the ego vehicle not obstructing the information cloud map for the environment sensors of the ego vehicle.

FIG. 5 shows a schematic view based on the second driving scenario of FIG. 4, where the ego vehicle is driving on the central driving lane and has reached a position laterally between the third party vehicles driving individually on the neighboring driving lanes, whereby the vehicles driving on the neighboring driving lanes are located besides the ego vehicle and obstruct the information cloud map for the environment sensors of the ego vehicle.

FIG. 6 shows a flow chart of a method for perception blockage prediction and supervision for performing information cloud localization in the ego vehicle of FIG. 1 based on an information cloud map and a sensor information cloud generated based on sensor information provided by the environment sensors of the ego vehicle.

### DETAILED DESCRIPTION

Detailed embodiments of the present invention are disclosed herein. It is to be understood that the disclosed embodiments are merely examples of the invention that may be embodied in various and alternative forms. The Figures are not necessarily to scale; some features could be exaggerated or minimized to show details of particular components. Therefore, specific structural and functional details disclosed herein are not to be interpreted as limiting, but merely as a representative basis for teaching one skilled in the art to variously employ the embodiments of the present invention. As those of ordinary skill in the art will understand, various features described and illustrated with reference to any one of the Figures can be combined with features illustrated in one or more other Figures to produce embodiments that are not explicitly described or illustrated. The combinations of features illustrated provide representative embodiments for typical applications. However, various modifications and combinations of the features consistent with the teachings of this disclosure may be desired for particular applications or implementations.

The present invention refers to a method for perception blockage prediction and supervision for performing information cloud localization in an ego vehicle based on an information cloud map and a sensor information cloud generated based on sensor information provided by at least one environment sensor of the ego vehicle.

The present invention also provides a driving support system for use in an ego vehicle comprising at least one environment sensor and a control unit, wherein the driving support system is adapted to perform the above method.

It is an object of the present invention to provide a method for perception blockage prediction and supervision for performing information cloud localization in an ego vehicle and a driving support system, which overcome at least some of the disadvantages of the state of the Art, and which in particular provide improvements in information cloud localization. It is a particular object of the present invention to enable safe handling of perception blockage situations when performing information cloud localization.

This object is achieved by the independent claims. Advantageous embodiments are given in the dependent claims.

In particular, the present invention provides a method for perception blockage prediction and supervision for performing information cloud localization in an ego vehicle based on an information cloud map and a sensor information cloud generated based on sensor information provided by at least one environment sensor of the ego vehicle, comprising the steps perceiving a surrounding of the ego vehicle, detecting and localizing at least one object in the surrounding of the ego vehicle, which is not contained in the information cloud map, determining a future obstruction of at least a part of the information cloud map for the at least one environment sensor of the ego vehicle based on the localization of the at least one object detected in the surrounding of the ego vehicle, and generating a warning in case a future obstruction of at least a part of the information cloud map has been determined.

The present invention also provides a driving support system for use in an ego vehicle comprising at least one environment sensor and a control unit, wherein the driving support system is adapted to perform the above method.

The basic idea of the invention is that when performing information cloud localization, perception blockage situations are anticipated in order to increase traffic safety. In particular applications like ADAS (advanced driving assistance system) or robotics are based on detailed knowledge in respect to a position of the ego vehicle. Based on possible velocities of state of the Art vehicles of up to 200 km/h and even more together with typical margins defined by e.g. a driving lane width of sometimes two to three meters, it is required to determine continuously and accurately the position of the ego vehicle in order to limit a risk when the ego vehicle is moving. This can in general be achieved by performing information cloud localization, since information cloud map based localization techniques can achieve a precision level comparable to other high-end localization technologies such as GNSS (Global Navigation Satellite System) with RTK correction (Real-Time Kinematic), whereby the information cloud localization is typically able to provide position information for the ego vehicle with a higher refresh rate compared to typical state of the Art GNSS. In case information cloud localization will not be possible due to obstructions of the information cloud map, this can be detected in advance and a respective warning can be generated. The warning can be handled appropriately in order to avoid dangerous driving situations. Without such anticipation of obstructions, the ego vehicle can run into situations, where the ego vehicle is literally “blind” and cannot determine its position.

The idea of information cloud localization is as following. The information cloud map provides a cloud-like representation of the environment of the vehicle. The information cloud map contains information in respect to typically non-movable objects, which together define the surrounding of the ego vehicle. The ego vehicle generates a similar representation of its surrounding using its environment sensors. Based on the information cloud map together with the sensor information cloud, a current position of the ego vehicle can be determined based on a matching of information items of the sensor information cloud and the information cloud map. Hence, a relative position of the ego vehicle in the information cloud map can be determined. Based on known positions of information elements provided in the information cloud, the relative position of the ego vehicle in the information cloud map can be used even to determine an absolute position of the ego vehicle, i.e. a unique position on earth. Taking this into account, being able to supervise an environment of the ego vehicle and to predict events of obstructions of the information cloud map by objects, in particular third party vehicles, and to generate a respective warning can be considered as essential for information cloud localization as performed e.g. in the ego vehicle.

The disclosed method provides supervision in respect to obstructions of the information cloud map by objects located in the surrounding of the ego vehicle, i.e. knowledge is provided in respect to possible obstructions. The prediction refers to a future obstruction and can be determined e.g. based on knowledge of the objects/information in the current surrounding, i.e. the information cloud map, together with information in respect to objects detected in the surrounding of the ego vehicle, which are in particular not visible in the information cloud map. This enables a prediction of a possible perception blockage.

In general, any suitable kind and number of environment sensors can be used for performing information cloud localization. Furthermore, the environment sensors can be located differently at the ego vehicle as long as a suitable placement of the environment sensors at the ego vehicle is given. Since sensor errors are typically increasing for objects further away, it can be preferred to focus on information items close by the ego vehicle to perform information cloud localization. This can be achieved for example by processing sensor information from environment sensors covering an environment laterally to the ego vehicle. Road boundaries, driving lane boundaries, curbs, guard rails as well as any kind of walls or even trees can be located next to the road or street on provide “information” relatively close by the ego vehicle.

According to a modified embodiment of the invention, the at least one environment sensor comprises at least one environment sensor out of a group of environment sensors comprising optical cameras, LiDAR-based environment sensors, radar sensors and ultrasonic sensors. Each of the environment sensors has particular advantages and disadvantages. By way of example, LiDAR-based environment sensors as well as radar sensors directly provide a sensor point cloud covering the surrounding of the ego vehicle, whereas optical cameras have advantages in respect object detection and classification. The environment sensors can be provided in any suitable kind, number and position at the ego vehicle. Preferred is a combination of different kinds of environment sensors.

The sensor information can be provided from the environment sensor(s) of the ego vehicle in any suitable way and format. The sensor information can be pre-processed or provided in raw format.

Perceiving the surrounding of the ego vehicle refers to a perception of objects in the surrounding of the ego vehicle.

Detecting and localizing at least one object in the surrounding of the ego vehicle refers to a detection of such objects, which are not contained in the information cloud map. Hence, the objects present in the sensor information cloud but not “visible” in the information cloud map can represent such objects. A comparison of the information cloud map and the sensor information cloud can show these objects and their positions.

The step of determining a future obstruction of at least a part of the information cloud map for the at least one environment sensor of the ego vehicle based on the localization of the at least one object detected in the surrounding of the ego vehicle is performed under consideration of possible future positions of the ego vehicle and/or the objects. This can take into account movements of the ego vehicle and/or the detected objects and other influencing factors. The obstruction refers to a mismatch between a part of the information cloud map actually “visible” for the environment sensor(s) compared to a part of the information cloud map that should be “visible” for the respective environment sensor(s).

Generating the warning refers to any suitable kind of warning, which is generated by the driving support system. The warning can be generated by a user interface of the driving support system or in general of the ego vehicle. Generating the warning can comprise e.g. raising a flag that is evaluated by the driving support system to undertake countermeasures in a subsequent step. These countermeasures can comprise one or more different steps e.g. based on a current traffic condition, currently applied autonomous driving mode, availability of redundant means for localization of the ego vehicle, or available fleet management systems, just to name a few.

Hence, by way of example, depending on a particular driving condition including e.g. further traffic participants, visibility, environment conditions or others, the ego vehicle may decide to perform a minimum risk maneuver to bring the ego vehicle to standstill at minimum risk. If possible, the ego vehicle may decide to adapt velocity and/or movement direction to avoid the minimum risk maneuver.

In some cases, the future obstruction can be avoided under consideration of a movement of the ego vehicle relative to the at least one object localized in the information cloud map. For example, when the detected object is moving, the ego vehicle can adapt its own velocity as countermeasure to maintain a pre-defined minimum distance to the detected object while driving. In other cases, a different trajectory can be chosen for the ego vehicle so that the obstruction can be avoided or at least reduced.

Depending on a currently applied autonomous driving mode, as a further countermeasure, the ego vehicle may decide to switch from a higher level autonomous driving mode to a lower level autonomous driving mode, whereby the lower level autonomous driving mode requires a higher degree of attention of a human driver inside the ego vehicle.

Furthermore, e.g. depending on availability of redundant means for localization of the ego vehicle, the ego vehicle may decide to perform localization based on such a redundant, i.e. different, means for localization of the ego vehicle, e.g. based on position signals received from a global navigation satellite system (GNSS) or using external means for localization, e.g. via infrastructure. The redundant localization of the ego vehicle based on position signals received from the GNSS can be performed using one or more out of currently available systems including NAVSTAR GPS (Global Positioning System), typically referred to as GPS only, GLONASS, Galileo or Beidou.

When the ego vehicle forms part of e.g. a fleet of vehicles managed by a fleet management system, the fleet management system may receive the information in respect to the future obstruction of at least a part of the information cloud map from the ego vehicle and adapt management of the comprised vehicles, e.g. to choose a different driving trajectory, to apply a reduced velocity in the area of the obstruction, or others.

According to a modified embodiment of the invention, the method comprises providing as information cloud map a point cloud map and/or a feature cloud map and as sensor information cloud a sensor point cloud and/or sensor feature map, respectively. The point cloud map as well as the sensor point cloud refer to a representation of objects in the surrounding of the ego vehicle based on single sensor points. Such sensor points are typically generated by LiDAR-based environment sensors as well as radar sensors, which directly provide a cloud of measurement points. The feature cloud map as well as the sensor feature map are typically based on object recognition techniques applied to images from optical cameras, which provide the respective objects as features. Positions of these features can be determined e.g. under combination of sensor information from LiDAR-based environment sensors or radar sensors, which are in general more reliable in respect to distances of the features. The different kinds of information elements, i.e. the point or the features, can provide alone or in combination a definition of the surrounding of the ego vehicle.

According to a modified embodiment of the invention, the step of perceiving a surrounding of the ego vehicle comprises receiving sensor information from at least one environment sensor of the ego vehicle, in particular from at least one environment sensor different to the at least one environment sensor providing the sensor information for generating the sensor information cloud. Two sets of environment sensors can be provided, so that at least one environment sensor provides the sensor information for generating the sensor information cloud and at least one environment sensor provides the sensor information for perceiving the surrounding of the ego vehicle. Each set of environment sensors may contain one or more environment sensors of any suitable kind. In particular, the at least one environment sensor providing the sensor information for perceiving the surrounding of the ego vehicle is located to monitor the surrounding of the ego vehicle in driving direction ahead of the ego vehicle. In this direction, relevant objects that may obstruct at least a part of the information cloud map are supposed to be detected. In contrast, information cloud localization is typically based on information elements of the information cloud map and a sensor information cloud closer by the vehicle, e.g. laterally next to the ego vehicle. This takes into account that sensor errors typically increase for objects further away. Depending on the kind of environment sensors and their location at the vehicle, it can be possible to use at least some of the environment sensors of the ego vehicle for providing the sensor information for generating the sensor information cloud and for perceiving the surrounding of the ego vehicle. In other cases, the two sets of environment sensors can cover different parts of the surrounding of the ego vehicle.

According to a modified embodiment of the invention, the step of perceiving a surrounding of the ego vehicle comprises providing a perception layer covering the surrounding of the ego vehicle, in particular based on a fusion of sensor information provided by multiple environment sensors. The perception layer can provide a map-like representation of the perception of the environment using the environment sensors of the ego vehicle. It typically contains detected features, i.e. traffic participants as well as non-mobile objects like houses or trees, which have been identified based on the sensor information provided by one or more environment sensors. Based on the perception layer, the future obstruction of at least a part of the information cloud map for the at least one environment sensor can be easily detected. For example, the perception layer can be overlaid to e.g. to the information cloud map to determine the future obstruction. Preferably, the perception layer is based on a fusion of the sensor information provided by multiple environment sensors, so that a high level of confidence in respect to the perception of the surrounding of the ego vehicle can be obtained. In addition to static information like a current position, the perception layer can additionally contain dynamic information, e.g. movement information in respect to the objects identified in the surrounding of the ego vehicle.

According to a modified embodiment of the invention, the step of detecting and localizing at least one object in the surrounding of the ego vehicle, which is not contained in the information cloud map, comprises assigning a position and preferably an identification to the at least one object detected in the surrounding of the ego vehicle. This facilitates a further processing. The position of the at least one object can be used as basis for extrapolation of a future position of the at least one object. The (future) position can be used as basis for determining the future obstruction of at least a part of the information cloud map. Together with the (future) position of the ego vehicle, in particular of the environment sensor(s) of the ego vehicle, and the information items of the information cloud map, the future obstruction can be reliably determined. The identification refers to a classification of the detected object(s) based on processing of the received sensor information in respect to the detected object(s), e.g. traffic participants as well as other objects. Hence, the object(s) can be referred to as features with the identification. The identification can provide additional information e.g. in respect to dimensions of the respective object and even in respect to a typical movement of the respective object. It can further help to identify a deficiency in the information cloud map, e.g. when a building is identified, which is not part of the information cloud map.

According to a modified embodiment of the invention, the step of determining a future obstruction of at least a part of the information cloud map for the at least one environment sensor of the ego vehicle based on the localization of the at least one object detected in the surrounding of the ego vehicle is performed under additional consideration of a field of view of the at least one environment sensor of the ego vehicle. Hence, a detailed obstruction can be determined for a respective environment sensor. The field of view can be used to determine in detail, if an obstruction of the respective environment sensor occurs. Furthermore, the field of view can be used to determine the future obstruction of at least a part of the information cloud map for the at least one environment sensor by determining an obstruction of the field of view of the respective environment sensors. Additionally or alternatively, the field of view can be used to determine a degree or level of obstruction of the part of the information cloud map, which would be visible without the obstruction by the at least one object. Vice versa, an environment sensor can be considered as obstructed when a major part of its field, e.g. more than a 50%, is covered by the at least one object. The obstruction of the field of view of the environment sensor is analogue to the obstruction of the information cloud map.

According to a modified embodiment of the invention, the step of determining a future obstruction of at least a part of the information cloud map for the at least one environment sensor of the ego vehicle based on the localization of the at least one object detected in the surrounding of the ego vehicle comprises determining a movement of the at least one object, and/or determining a movement of the ego vehicle, and the step of determining a future obstruction of at least a part of the information cloud map for the at least one environment sensor of the ego vehicle based on the localization of the at least one object detected in the surrounding of the ego vehicle is performed under additional consideration of the determined movement of the at least one object and/or the determined movement of the ego vehicle. Accordingly, a detailed comparison of the positions of the ego vehicle and the at least one object can be performed in order to determine the future obstruction. Respective technologies for estimating future positions of moving objects based e.g. on extrapolation of a current position and movement can be used. Hence, in case an object is located at one side of the ego vehicle, and the ego vehicle is driving in a direction towards this object, an obstruction is likely to occur in the future. Based on the determined movement of the at least one object and/or the ego vehicle, this obstruction can be determined with increased accuracy and more detail, e.g. including a start time/position of the obstruction and/or duration of the obstruction.

According to a modified embodiment of the invention, the step of determining a future obstruction of at least a part of the information cloud map for the at least one environment sensor of the ego vehicle based on the localization of the at least one object detected in the surrounding of the ego vehicle comprises determining an obstruction level, in particular an obstruction level for the at least one environment sensor of the ego vehicle, and the step of generating a warning in case a future obstruction of at least a part of the information cloud map has been determined comprises generating the warning under additional consideration of the obstruction level, in particular the obstruction level for the at least one environment sensor of the ego vehicle. The obstruction level can be for example a ratio of a part of the information cloud map “visible” compared to a part of the information cloud map not “visible” due to the obstruction. This can include a ratio of information items “visible” compared to information items not “visible” due to the obstruction. Hence, in case the information items are not equally distributed, an obstruction can occur essentially independent from a size of the obstruction. As long as sufficient information items are can be determined in the provided senor information, an obstruction does not occur. Additionally or alternatively, the obstruction level can be determined independently from the “visible” information items. For example, a ratio of an obstructed part compared to a non-obstructed part of the information cloud map can be determined as obstruction level. The ratio can be based e.g. on an angular coverage of the information cloud map with the ego vehicle as center. When referring to the individual environment sensors, the obstruction level can be determined as a ratio of the field of view compared to an obstructed part of the field of view of the respective environment sensor. This way, the obstruction level can be determined for each environment sensor individually. An overall obstruction level can be determined by determining the obstruction level over all environment sensors of the ego vehicle. Based on the obstruction levels of the environment sensors, an overall obstruction level can be determined based on a percentage of obstructed environment sensors. Alternatively, the obstruction level can be determined based on an average obstruction level of the environment sensors. However, in addition to the obstruction level, a warning in respect to the future obstruction can be generated based on an additional consideration of a minimum number of information elements in the surrounding of the ego vehicle that are not obstructed. Hence, as long as at least this minimum number of information elements is not obstructed, a warning can be suppressed. Furthermore, the number of information elements in the surrounding of the ego vehicle that are not obstructed can be combined with the obstruction level to generate the warning.

According to a modified embodiment of the invention, the step of generating a warning in case a future obstruction of at least a part of the information cloud map has been determined comprises generating the warning to a human occupant of the ego vehicle, in particular a human driver, and/or generating an internal warning to an autonomous driving system of the ego vehicle. Generating the warning to the human occupant of the ego vehicle can be done using any user interface of the ego vehicle or the driving support system of the ego vehicle, e.g. generating an acoustic and/or visible warning signal. This can help the occupant to prepare to possible countermeasures and or to take over control of the ego vehicle. Generating the internal warning to the autonomous driving system of the vehicle can comprise e.g. raising a flag that is evaluated by the driving support system to undertake countermeasures in a subsequent step. These countermeasures can comprise one or more different steps e.g. based on a current traffic condition, currently applied autonomous driving mode, availability of redundant means for localization of the ego vehicle, or available fleet management systems, just to name a few. Some possible countermeasures have already been discussed above.

Feature and advantages described above with reference to the inventive method apply equally to the inventive driving support system and vice versa.

These and other aspects of the invention will be apparent from and elucidated with reference to the embodiments described hereinafter. Individual features disclosed in the embodiments can constitute alone or in combination an aspect of the present invention. Features of the different embodiments can be carried over from one embodiment to another embodiment.

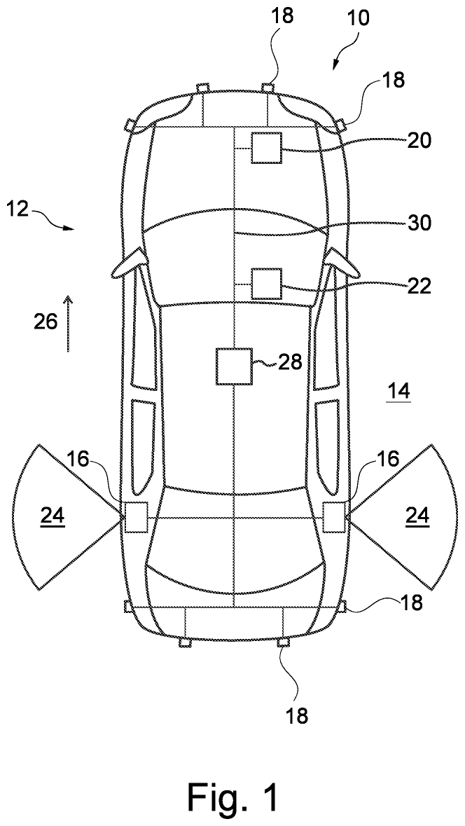

FIG. 1 shows an ego vehicle 10 with a driving support system 12 according to a first, preferred embodiment.

The driving support system 12 monitors an environment 14 of the ego vehicle 10. Hence, the driving support system 12 comprises multiple environment sensors 16, 18, 20, 22, which are located at different sides of the ego vehicle 10.

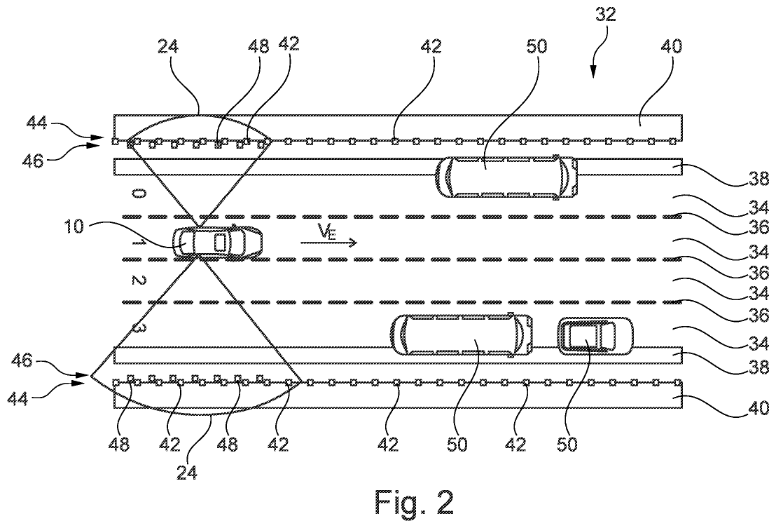

In detail, the driving support system 12 of the first embodiment comprises two lateral LiDAR-based environment sensors 16, further referred to as lateral LiDARs. The lateral LiDARs 16 are located at left and right lateral sides of the ego vehicle 10 with a field of view 24 approximately centered orthogonally at the lateral sides of the ego vehicle 10, as can also be seen in FIGS. 2 to 5. In the Figure, the field of view 24 seems to be limited to a distance shorter than a length of the ego vehicle 10. This is merely due to the visualization of the field of view 24 in the Figures. The field of view 24 of the lateral LiDARs 16 can have an extension of several tens of meters and even several hundreds of meters, depending on a particular implementation of the lateral LiDARs 16.

The driving support system 12 of the first embodiment further comprises two groups of ultrasonic sensors 18, which are located at a front side and a rear side of the ego vehicle 10.

The driving support system 12 of the first embodiment additionally comprises a front LiDAR-based environment sensor 20, further referred to as front LiDAR, and an optical camera 22. Each of the front LiDAR 20 and the optical camera 22 have respective field of view 24, which is directed to a front side of the ego vehicle 10. Hence, when driving forward, as indicated by driving direction 26, the front LiDAR 20 and the optical camera 22 monitor the surrounding 14 of the ego vehicle 10 in the driving direction 26 ahead of the ego vehicle 10. Each of the environment sensors 16, 18, 20, 22 generates sensor information, which can comprise raw data or pre-processed data.

In an alternative embodiment, the driving support system 12 comprises a different set of environment sensors 16, 18, 20, 22 out of LiDAR-based environment sensors 16, 20, optical cameras 22, ultrasonic sensors 18 and radar sensors, which can be located in any suitable number at any suitable position of the ego vehicle 10, e.g. including environment sensors 16, 18, 20, 22 covering a rear side of the ego vehicle 10.

The ego vehicle 10 of the first embodiment further comprises a control unit 28 and a data connection 30, which interconnects the environment sensors 16, 18, 20, 22 and the control unit 28. The control unit 28 can be any kind of control unit 28 suitable for the use in the ego vehicle 10. Such control units 28 are typically known as ECU (electronic control unit) in the automotive area. The control unit 28 can be shared for performing multiple tasks or applications. The control unit 28 receives the sensor information from the environment sensors 16, 18, 20, 22 and processes the received sensor information, as further discussed below. The sensor information can be provided from the environment sensors 16, 18, 20, 22 of the ego vehicle 10 in any suitable way and format. The sensor information can be pre-processed or raw sensor data.

The data connection 30 can be a dedicated connection between the environment sensors 16, 18, 20, 22 and the control unit 28, or a data bus. Furthermore, the data connection 30 can be a shared data connection 30 used by different kinds of devices of the ego vehicle 10, e.g. a multi-purpose data bus. The data connection 30 can be implemented e.g. as CAN-bus, LIN-bus, or others. The data connection 30 can be a single data connection 30 connecting the environment sensors 16, 18, 20, 22 and the control unit 28. Although a single data connection 30 is depicted in FIG. 1, multiple data connections 30 or data busses can be provided in parallel for connecting environment sensors 16, 18, 20, 22 to the control unit 28. In this case, the multiple data connections 30 or data busses can be considered together as data connection 30.

The sensor information from the environment sensors 16, 18, 20, 22 is transferred to the control unit 28 via the data connection 30. Although a single control unit 28 is depicted in FIG. 1, multiple individual units can be provided, which together implement the control unit 28.

The environment sensors 16, 18, 20, 22 form a set of environment sensors 16, 18, 20, 22. The sensor information from the environment sensors 16, 18, 20, 22 is processed together by the control unit 28. The control unit 28 fuses the sensor information received from the environment sensors 16, 18, 20, 22, as discussed below in more detail.

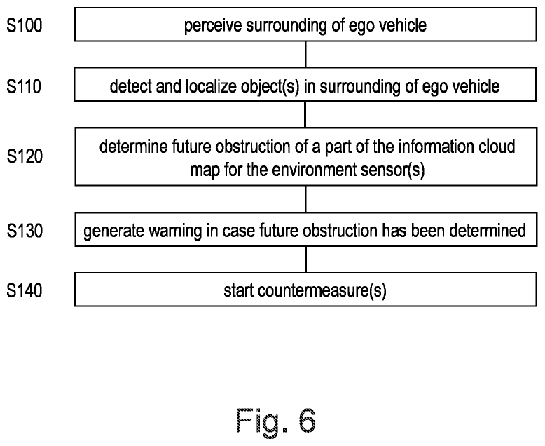

Subsequently will be described a method for perception blockage prediction and supervision for performing information cloud localization in an ego vehicle 10 based on an information cloud map and a sensor information cloud generated based on sensor information provided by the environment sensors 16, 18, 20, 22 of the ego vehicle 10 according to the first embodiment. A flow chart of the method is shown in FIG. 6. The method will be described with further reference to driving situations depicted in FIGS. 2 to 5. The method is performed using the driving support system 12 of the first embodiment.

The method is based on information cloud localization, which will be discussed now with reference to FIGS. 2 to 5. As can be seen in FIGS. 2 to 5, the ego vehicle 10 is driving on a street or road 32 with four driving lanes 34, which are additionally numbered from 0 to 3 in the Figures. The driving lanes 34 are separated by driving lane separators 36, i.e. dashed lines painted on the street or road 32. The street or road 32 is delimited by curbs 38. By way of example, walls 40 are provided behind the curbs 38 at both sides of the street or road 32, which belong e.g. to rows of buildings or other structures.

In this embodiment, information cloud localization is performed based on information points 42, which together provide a point cloud map 44 as information cloud map. The point cloud map 44 covers the surrounding 14 of the ego vehicle 10 with its information points 42, as can be seen by way of example in FIGS. 2 to 5, where the information points 42 are located at the walls 40. The point cloud map 44 is provided from an external data source to the ego vehicle 10 and stored therein.

In accordance with the point cloud map 44, the driving support system 12 provides as sensor information cloud a sensor point cloud 46. The sensor point cloud 46 refers to a representation of the surrounding 14 of the ego vehicle 10 based on single sensor points 48. The sensor points 48 are generated using the lateral LiDARs 16 in this embodiment, which directly provide such sensor points 48. Additional sensor fusion can be performed based on sensor information provided from the further environment sensors 16, 18, 20, 22 of the ego vehicle 10 to increase confidence in the sensor points 48. In FIGS. 2 to 5, the sensor points 48 are shown in the respective fields of view 24 of the lateral LiDARs 16.

Based on the information points 42 of the point cloud map 44 together with the sensor points 48 of the sensor point cloud 46, a current position of the ego vehicle 10 can be determined based on matching the information points 42 of the point cloud map 44 with the sensor points 48 of the sensor point cloud 46. Hence, a relative position of the ego vehicle 10 in respect of the information points 42 can be determined. Based on known positions of the information points 42 of the point cloud map 44, the relative position of the ego vehicle 10 can be used as basis to determine an absolute position of the ego vehicle 10, i.e. a unique position on earth.

The method for perception blockage prediction and supervision is performed in the context of performing information cloud localization with the ego vehicle 10 as discussed above.

The method starts with step S100, which refers to perceiving the surrounding 14 of the ego vehicle 10 with a perception of objects 50 in the surrounding 14 of the ego vehicle 10.

In detail, a perception layer is generated, which covers the surrounding 14 of the ego vehicle 10. In this embodiment, the perception layer is based on a fusion the of sensor information provided by the environment sensors 16, 18, 20, 22. Hence, the perception layer is provided using the environment sensors 16, 18, 20, 22 of the ego vehicle 10, which are in this embodiment also used for providing the sensor point cloud 46. The perception layer can comprise a map-like representation of the perception of the surrounding 14 of the ego vehicle 10. The perception layer contains static information and additionally dynamic information, e.g. movement information in respect to objects 50 identified in the surrounding 14 of the ego vehicle 10.

Hence, the sensor information received from the environment sensors 16, 18, 20, 22 of the ego vehicle 10 is commonly processed to generate the perception layer. The control unit 28 processes and fuses the sensor information received form the environment sensors 16, 18, 20, 22 via the data connection 28. In this embodiment, the perception layer is generated based on the same environment sensors 16, 18, 20, 22, which also provide the sensor information for generating the sensor point cloud 46. Hence, the perception layer can be provided as general purpose perception layer, and the use of the perception layer is not limited to particular needs of the described method, so that it can be used as general source of information for different applications of the ego vehicle 10. However, most important information provided in respect to perception blockage prediction refers to sensor information covering a part of the surrounding 14 of the ego vehicle 10 in driving direction 26 ahead of the ego vehicle 10. In this part of the surrounding 14 of the ego vehicle 10, relevant objects 50 that may obstruct at least a part of the point cloud map 44 are supposed to be detected.

Accordingly, the perception layer contains the objects 50 as detected features, i.e. traffic participants as well as non-mobile objects 50 like houses or trees, which have been identified based on the sensor information provided by the environment sensors 16, 18, 20, 22.

Step S110 refers to detecting and localizing at least one object 50 in the surrounding 14 of the ego vehicle 10. This refers in particular to a detection of such objects 50, which are not contained in the point cloud map 44.

The objects 50 can be identified and localized e.g. based on a comparison of the point cloud map 44 and the sensor point cloud 46, which can show these objects 50 and their positions. This information can be added to the perception layer.

The step of detecting and localizing at least one object 50 in the surrounding 14 of the ego vehicle 10 comprises assigning a position and preferably an identification to the respective object 50.

The position of each of the detected objects 50 is used as basis for extrapolation of a future position of the respective object 50. Furthermore, the sensor information in respect to the object(s) 50 in the surrounding 14 of the ego vehicle 10 are processed to detect features, i.e. mobile objects 50 like traffic participants as well as non-mobile objects 50 like houses or trees. This provides the identification of the respective object 50.

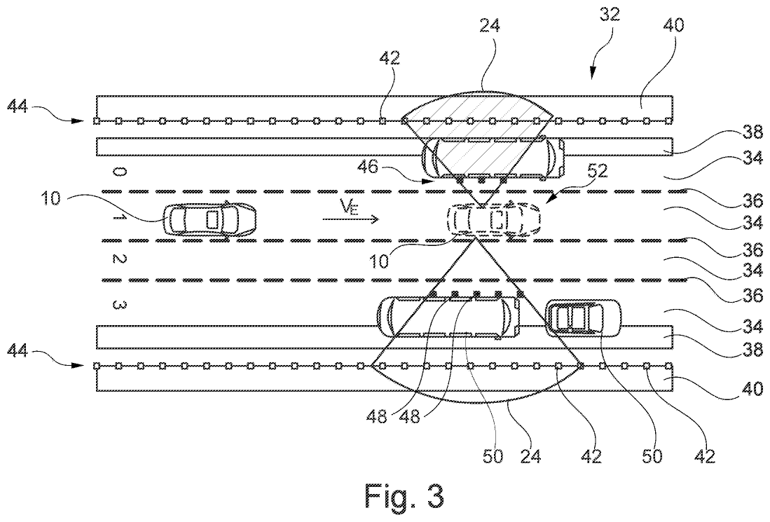

A first driving example is depicted in FIGS. 2 and 3. As can be seen in FIG. 2, the ego vehicle 10 is moving with velocity v_{E} in a driving lane 34 and approaches several objects 50, which are third party vehicles in this example. The third party vehicles 50 are not moving and are parked in positions at the curb 38 of the street or road 32 ahead of the ego vehicle 10. The third party vehicles 50 are detected as objects 50 with the front LiDAR 20 and the optical camera 22. As discussed above, the objects 50 are localized. A position of each of the third party vehicles 50 is assigned together with an identification based on a classification of the objects 50 and additionally together with their velocity, which is zero.

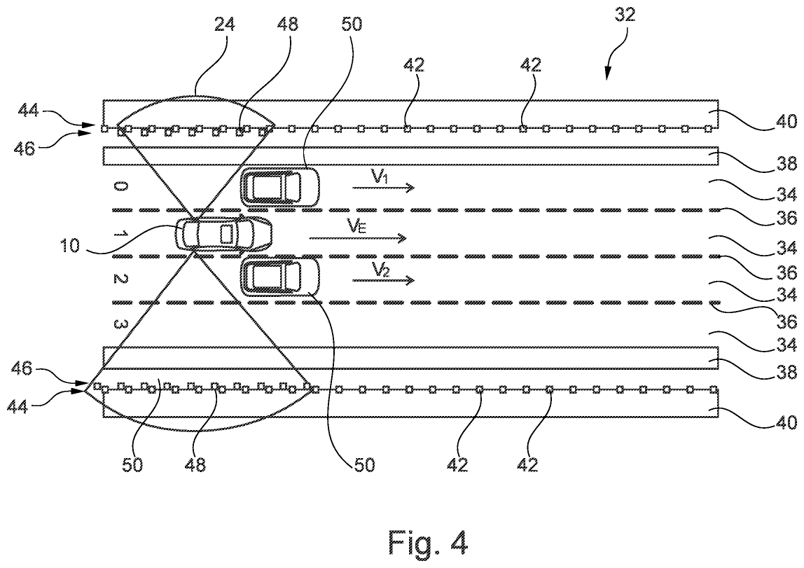

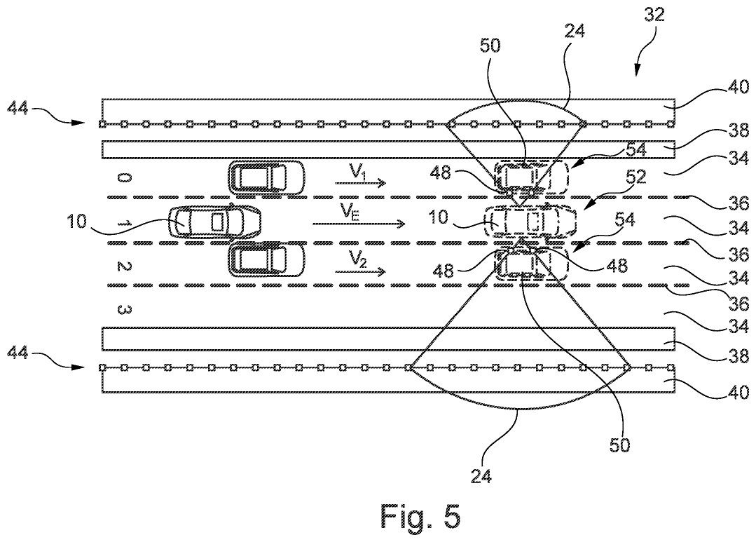

A second driving example is depicted in FIGS. 4 and 5. As can be seen in FIG. 4, the ego vehicle 10 is moving with velocity v_{E} in a driving lane 34. Several objects 50, which are third party vehicles in this example, are moving in neighboring driving lanes 34 with respective velocities v₁ and v₂. The third party vehicles 50 are detected as objects 50 with the environment sensors 16, 18, 20, 22 of the ego vehicle 10. As discussed above, the objects 50 are localized. A position of each of the third party vehicles 50 is assigned together with an identification based on a classification of the objects 50 and additionally together with their velocity.

Step S120 refers to determining a future obstruction of at least a part of the information cloud map 44 for the environment sensors 16, 18, 20, 22 of the ego vehicle 10 based on the localization of the at least one object 50 detected in the surrounding 14 of the ego vehicle 10.

Step S120 is performed under consideration of possible future positions of the ego vehicle 10 and the object(s) 50. This takes into account movements of the ego vehicle 10 and the object(s) 50. Hence, movements of the object(s) 50 and of the ego vehicle 10 are determined, as already discussed above. Accordingly, the future obstruction of at least a part of the information cloud map 44 is performed under additional consideration of the determined movement of the object(s) 50 and the determined movement of the ego vehicle 10. For example, in case an object 50 is located at one side of the ego vehicle 10, and the ego vehicle is moving in a direction towards this object 50, an obstruction is likely to occur in the future, as can be seen with respect to FIGS. 2 and 3 as well as FIGS. 4 and 5.

The movement of the object(s) 50 and the ego vehicle 10 can be used to determine future positions of the object(s) 50 and the ego vehicle 10. In particular, the movements of the object(s) 50 and the ego vehicle 10 can be used to extrapolate future positions of the object(s) 50 and the ego vehicle 10 and to determine the future obstruction based on these extrapolated future positions. Together with the positions of the information items of the point cloud map 44, the future obstruction can be determined.

Furthermore, the determination of the future obstruction of at least a part of the information cloud map 44 for the at least one environment sensor 16, 18, 20, 22 of the ego vehicle 10 is performed under additional consideration of the fields of view 24 of the respective environment sensors 16, 18, 20, 22 of the ego vehicle 10. In this case, the localization of the ego vehicle 10 is based on the lateral LiDARs 16, so that the fields of view 24 of these environment sensors 16, 18, 20, 22 are considered.

The fields of view 24 are used to determine in detail, if a future obstruction of the lateral LiDARs 16, which are used for providing the sensor point cloud 48 and for performing information cloud localization in the ego vehicle 10, occurs. The obstruction is therefore determined based on the fields of view 24 of the lateral LiDARs 16.

Additionally, the fields of view are used to determine an obstruction level of the part of the information cloud map 44 for the lateral LiDARs 16 of the ego vehicle 10. Hence, a ratio of an obstructed part of the point cloud map 44 compared to a non-obstructed part of the point cloud map 44 is determined as obstruction level. This refers to a part of the point cloud map 44 “visible” without the detected object(s) 50 compared to a part of the point cloud map 44 still “visible” under consideration of the obstruction by the detected object(s) 50. This can include a ratio of information items “visible” compared to information items not “visible” due to the obstruction. In an alternative embodiment, the obstruction level is determined. Alternatively, the obstruction level can be determined as a ratio of the field of view 24 of the two lateral LiDARs 16 compared to an obstructed part of the field of view 24 of the lateral LiDARs 16. This way, the obstruction level can be determined for each of the lateral LiDARs 16 individually or commonly for both lateral LiDARs 16.

As can be seen in FIG. 3 for the first driving example, a future position 52 of the ego vehicle 10 is determined based on the determined velocity v_{E} of the ego vehicle 10. The future position 52 of the ego vehicle 10 is additionally indicated by the ego vehicle 10 shown with dashed lines. At the future position 52 of the ego vehicle 10, some of the third party vehicles 50 are located directly next to the ego vehicle 10 and obstruct the part of the point cloud map 44 of the respective fields of view 24 of the two lateral LiDARs 16. The sensor points 48 of the two lateral LiDARs 16 are generated at the third party vehicles 50 located laterally to the ego vehicle 10, so that they cannot be matched with the information points 42 of the respective part of the point cloud map 44, which is covered by the fields of view 24 depicted in FIG. 3.

As can be seen similarly in FIG. 5 for the second driving example, a future position 52 of the ego vehicle 10 is determined based on the determined velocity v_{E} of the ego vehicle 10. The future position 52 of the ego vehicle 10 is additionally indicated by the ego vehicle 10 shown with dashed lines. Furthermore, future positions 54 of the third party vehicles 50 are determined based on the determined velocities v₁ and v₂. The future positions 54 of the third party vehicles 10 are additionally indicated by the third party vehicles 50 shown with dashed lines. At the future positions 52, 54 of the ego vehicle 10 and the third party vehicles 50, the third party vehicles 50 are located directly next to the ego vehicle 10 and obstruct the part of the point cloud map 44 of the respective fields of view 24 of the two lateral LiDARs 16. The sensor points 48 of the two lateral LiDARs 16 are generated at the third party vehicles 50 located laterally to the ego vehicle 10, so that they cannot be matched with the information points 42 of the respective part of the point cloud map 44, which is covered by the fields of view 24 depicted in FIG. 3.

Step S130 refers to generating a warning in case a future obstruction of at least a part of the information cloud map 44 has been determined.

Generating the warning refers to generating any suitable kind of warning, which is generated by the driving support system 12. The warning can be generated by a user interface of the driving support system 12 or in general of the ego vehicle 10, e.g. generating an acoustic and/or visible signal. Hence, the warning is generated to a human occupant of the ego vehicle 10.

Generating the warning additionally comprises e.g. raising a flag as internal warning to an autonomous driving system of the ego vehicle 10. The flag is evaluated by the driving support system 12 to undertake countermeasures in subsequent step S140.

The warning is generated under additional consideration of the determined obstruction level based two lateral LiDARs 16 of the ego vehicle 10. In case the obstruction level indicates that information cloud localization cannot be performed reliably anymore in the ego vehicle 10, the warning is generated. However, as long as a minimum number of information elements of the point cloud map 44 in the surrounding of the ego vehicle 10 are not obstructed, the warning is suppressed.

Accordingly, for each of the first and second driving example, the warning is generated, since in both driving examples a full future obstruction of the information cloud map 44 for the two lateral LiDARs 16 of the ego vehicle 10 occurs, so that information cloud localization cannot be performed at the future position 52 of ego vehicle 10, as shown in FIGS. 3 and 5. A full obstruction occurs in both driving examples.

Step S140, which is optional in this case and can be part of a subsequent processing, refers to starting countermeasures upon the generated warning.

The countermeasures can comprise one or more different steps e.g. based on a current traffic condition, a currently applied autonomous driving mode, availability of redundant means for localization of the ego vehicle 10, or availability of a fleet management system.

In one embodiment, the countermeasures comprise performing a minimum risk maneuver to bring the ego vehicle 10 to standstill at minimum risk. If possible, the ego vehicle 10 may decide to adapt velocity and/or trajectory to avoid the minimum risk maneuver. The decision for the minimum risk maneuver can depend on a particular driving condition including e.g. further traffic participants, visibility, environment conditions or others.

In another embodiment, the countermeasures comprise avoiding the future obstruction under consideration of the movement of the ego vehicle 10 relative to the respective object(s) 50 localized in the information cloud map 44 under consideration of the movement of the object(s) 50. Hence, the ego vehicle 10 adapts its own velocity to keep a pre-defined distance to the object(s) 50. In other cases, a different trajectory can be chosen for the ego vehicle 10.

Depending on a currently applied autonomous driving mode, in still another embodiment, the countermeasures comprise switching from a higher level autonomous driving mode to a lower level autonomous driving mode, whereby the lower level autonomous driving mode requires a higher degree of attention of a human driver inside the ego vehicle 10.

In yet another embodiment, the countermeasures comprise performing localization based on redundant, i.e. different, means for localization of the ego vehicle 10, e.g. based on position signals received from a global navigation satellite system (GNSS) or using external means for localization, e.g. via infrastructure, upon availability. The redundant localization of the ego vehicle 10 based on position signals received from the GNSS can be performed using one or more out of currently available systems including NAVSTAR GPS (Global Positioning System), typically referred to as GPS only, GLONASS, Galileo or Beidou.

In a further embodiment, when the ego vehicle 10 forms part of e.g. a fleet of vehicles managed by a fleet management system, the countermeasures comprise transmitting the information in respect to the future obstruction of at least a part of the information cloud map 44 from the ego vehicle 10 to the fleet management system and adapting management of the comprised vehicles, e.g. choosing a different driving trajectory, applying a reduced velocity in the area of the obstruction, or others.

The methods, processes, or algorithms disclosed herein can be deliverable to or implemented by a processing device, controller, or computer, which can include any existing programmable electronic control unit or dedicated electronic control unit. Also, the methods, processes, or algorithms can be implemented in a software executable object. Furthermore, the methods, processes, or algorithms can be stored as data and instructions executable by a controller or computer in many forms including, but not limited to, information permanently stored on non-writable storage media, such as ROM devices, and information alterably stored on writeable storage media, such as floppy disks, magnetic tapes, CDs, RAM devices, and other magnetic and optical media. Computing devices described herein generally include computer-executable instructions, where the instructions may be executable by one or more computing or hardware devices, such as those listed above. Such instructions and other data may be stored and transmitted using a variety of computer-readable media. Computer-executable instructions may be compiled or interpreted from computer programs created using a variety of programming languages and/or technologies, including, without limitation, and either alone or in combination, Java™, C, C++, Visual Basic, Java Script, Perl, etc. In general, a processor (e.g., a microprocessor) receives instructions (e.g., from a memory, a computer-readable medium, etc.) and executes these instructions, thereby performing one or more processes, including one or more of the processes described herein. Moreover, the methods, processes, or algorithms can be embodied in whole or in part using suitable hardware components, such as Application Specific Integrated Circuits (ASICs), Field-Programmable Gate Arrays (FPGAs), state machines, controllers or other hardware components or devices, or a combination of hardware, software and firmware components.

While exemplary embodiments are described above, it is not intended that these embodiments describe all possible forms encompassed by the claims of the invention. While the present disclosure is described with reference to the figures, it will be understood by those skilled in the art that various changes may be made and equivalents may be substituted without departing from the scope and spirit of the present disclosure. The words used in the specification are words of description rather than limitation, and it is further understood that various changes may be made without departing from the scope and spirit of the invention disclosure. In addition, various modifications may be applied to adapt the teachings of the present disclosure to particular situations, applications, and/or materials, without departing from the essential scope and spirit thereof. Additionally, the features of various embodiments can be combined to form further embodiments of the invention that may not be explicitly described or illustrated. While various embodiments may have been described as providing advantages or being preferred over other embodiments or prior art implementations with respect to one or more desired characteristics, those of ordinary skill in the art recognize that one or more features or characteristics could be compromised to achieve desired overall system attributes, which depend on the specific application and implementation. These attributes can include, but not limited to, strength, cost, durability, life cycle cost, appearance, marketability, size, packaging, weight, serviceability, manufacturability, ease of assembly, etc. Therefore, to the extent any embodiments are described as less desirable than other embodiments or prior art implementations with respect to one or more characteristics, these embodiments are not outside the scope of the disclosure and can be desirable for particular applications. Thus, the present disclosure is thus not limited to the particular examples disclosed herein, but includes all embodiments falling within the scope of the appended claims.

What is claimed is:

1. A method for perception blockage prediction and supervision for performing information cloud localization in an ego vehicle based on an information cloud map and a sensor information cloud generated based on sensor information provided by at least one environment sensor of the ego vehicle, comprising:
perceiving a surrounding of the ego vehicle;
detecting and localizing at least one object in the surrounding of the ego vehicle, which is not contained in the information cloud map;
determining a future obstruction of at least one part of the information cloud map for the at least one environment sensor of the ego vehicle based on the localization of the at least one object detected in the surrounding of the ego vehicle; and
generating a warning in case the future obstruction of the at least one part of the information cloud map has been determined.

2. The method of claim 1, further comprising
providing, as the information cloud map, a point cloud map or a feature cloud map; and
providing, as the sensor information cloud, a sensor point cloud or sensor feature map.

3. The method of claim 1, wherein the perceiving the surrounding of the ego vehicle includes
receiving the sensor information from the at least one environment sensor of the ego vehicle, in particular from at least one environment sensor different to the at least one environment sensor providing the sensor information for generating the sensor information cloud.

4. The method of claim 1, wherein the perceiving the surrounding of the ego vehicle includes
providing a perception layer covering the surrounding of the ego vehicle, in particular based on a fusion of the sensor information provided by multiple environment sensors.

5. The method of claim 1, wherein the detecting and localizing the at least one object in the surrounding of the ego vehicle, which is not contained in the information cloud map, includes
assigning a position and preferably an identification to the at least one object detected in the surrounding of the ego vehicle.

6. The method of claim 1, wherein the determining the future obstruction of the at least one part of the information cloud map for the at least one environment sensor of the ego vehicle based on the localization of the at least one object detected in the surrounding of the ego vehicle
is performed under additional consideration of a field of view of the at least one environment sensor of the ego vehicle.

7. The method of claim 1, wherein the determining the future obstruction of the at least one part of the information cloud map for the at least one environment sensor of the ego vehicle based on the localization of the at least one object detected in the surrounding of the ego vehicle includes
determining a movement of the at least one object or the ego vehicle; and
performing under additional consideration of the determined movement of the at least one object or the ego vehicle.

8. The method of claim 1, wherein the determining the future obstruction of the at least one part of the information cloud map for the at least one environment sensor of the ego vehicle based on the localization of the at least one object detected in the surrounding of the ego vehicle includes
determining an obstruction level for the at least one environment sensor of the ego vehicle; and
the generating the warning in case the future obstruction of the at least one part of the information cloud map has been determined comprises
generating the warning under additional consideration of the obstruction level for the at least one environment sensor of the ego vehicle.

9. The method of claim 1, wherein the generating the warning in case the future obstruction of the at least one part of the information cloud map has been determined includes
generating the warning to at least one of a human occupant of the ego vehicle, or generating an internal warning to an autonomous driving system of the ego vehicle.

10. A driving support system for use in an ego vehicle, comprising:
at least one environment sensor and a control unit adapted to:
perceive a surrounding of the ego vehicle;
detect and localize at least one object in the surrounding of the ego vehicle, which is not contained in the information cloud map;
determine a future obstruction of at least one part of the information cloud map for the at least one environment sensor of the ego vehicle based on the localization of the at least one object detected in the surrounding of the ego vehicle; and
generate a warning in case the future obstruction of the at least one part of the information cloud map has been determined.

11. The driving support system of claim 10, wherein the at least one environment sensor comprises at least one of optical cameras, LiDAR-based environment sensors, radar sensors and ultrasonic sensors.

12. The driving support system of claim 10, further comprising
provide, as the information cloud map, a point cloud map or a feature cloud map; and
provide, as the sensor information cloud, a sensor point cloud or sensor feature map.

13. The driving support system of claim 10, wherein the perceive the surrounding of the ego vehicle includes
receiving the sensor information from the at least one environment sensor of the ego vehicle, in particular from at least one environment sensor different to the at least one environment sensor providing the sensor information for generating the sensor information cloud.

14. The driving support system of claim 10, wherein the perceive the surrounding of the ego vehicle includes
providing a perception layer covering the surrounding of the ego vehicle, in particular based on a fusion of the sensor information provided by multiple environment sensors.

15. The driving support system of claim 10, wherein the detect and localize the at least one object in the surrounding of the ego vehicle, which is not contained in the information cloud map includes
assign a position and preferably an identification to the at least one object detected in the surrounding of the ego vehicle.

16. The driving support system of claim 10, wherein the determine the future obstruction of the at least one part of the information cloud map for the at least one environment sensor of the ego vehicle based on the localization of the at least one object detected in the surrounding of the ego vehicle
is performed under additional consideration of a field of view of the at least one environment sensor of the ego vehicle.

17. The driving support system of claim 10, wherein the determine the future obstruction of the at least one part of the information cloud map for the at least one environment sensor of the ego vehicle based on the localization of the at least one object detected in the surrounding of the ego vehicle includes
determine a movement of the at least one object or the ego vehicle; and
perform under additional consideration of the determined movement of the at least one object or the ego vehicle.

18. The driving support system of claim 10, wherein the determine the future obstruction of the at least one part of the information cloud map for the at least one environment sensor of the ego vehicle based on the localization of the at least one object detected in the surrounding of the ego vehicle includes
determine an obstruction level for the at least one environment sensor of the ego vehicle; and
the generate the warning in case the future obstruction of the at least one part of the information cloud map has been determined comprises
generate the warning under additional consideration of the obstruction level, in particular the obstruction level for the at least one environment sensor of the ego vehicle.

19. The driving support system of claim 10, wherein the generate the warning in case the future obstruction of the at least one part of the information cloud map has been determined includes
generate the warning to at least one of a human occupant of the ego vehicle, or generating an internal warning to an autonomous driving system of the ego vehicle.

20. A non-transitory computer-readable storage medium storing instructions, which when executed on a computer, cause the computer to perform a method for perception blockage prediction and supervision for performing information cloud localization in an ego vehicle based on an information cloud map and a sensor information cloud generated based on sensor information provided by at least one environment sensor of the ego vehicle, the method comprising:
perceiving a surrounding of the ego vehicle;
detecting and localizing at least one object in the surrounding of the ego vehicle, which is not contained in the information cloud map;
determining a future obstruction of at least one part of the information cloud map for the at least one environment sensor of the ego vehicle based on the localization of the at least one object detected in the surrounding of the ego vehicle; and
generating a warning in case the future obstruction of the at least one part of the information cloud map has been determined.
